(19) United States
(12) Patent Application Publication
(10) Pub. No.: US 2014/0026358 A1
(43) Pub. Date: Jan. 30, 2014

(54) ASSIST DEVICE FOR MOVABLE BODY, AND HOUSING

(71) Applicant: Norio Saito, Fujisawa-shi (JP)

(72) Inventor: Norio Saito, Fujisawa-shi (JP)

(73) Assignee: NIFCO INC., Yokohama-shi, Kanagawa (JP)

(21) Appl. No.: 14/004,789

(22) PCT Filed: Mar. 13, 2012
(86) PCT No.: PCT/JP2012/056453

§ 371 Date: Oct. 7, 2013

(30) Foreign Application Priority Data
Mar. 14, 2011 (JP) 2011-055894

(51) Int. Cl. E05F 1/16; E05F 3/00

(52) U.S. Cl. CPC E05F 1/16; E05F 3/00
USPC 16/72

(57) ABSTRACT

A housing of an assisting apparatus according an embodiment is a housing of an assisting apparatus provided on a receiving part formed on either one of a support body and a movable body that moves sliding in a first direction relative to the support body. The housing of an assisting apparatus has a support part that projects in a second direction intersecting with the first direction and is supported on a support surface of the receiving part; and a separated part that stands at a distance from the support surface.

### TECHNICAL FIELD

The present invention relates to a movable body assisting apparatus and housing for assisting movement of various kinds of movable bodies.

### BACKGROUND TECHNOLOGY

There is known a movable body assisting apparatus that forcibly moves and buffers movement using an urging mechanism and a damping mechanism in order to assist movement of a sliding door or other movable body (see, for example, Patent Document 1). In this kind of assisting apparatus, for example, a housing is embedded in the side of the sliding door and a slidable contact body is held inside this housing. Also, a received body that is captured by the contact body is provided on the side of the door frame. Furthermore, a piston damper as the damping mechanism and a tension coil spring as the urging mechanism, being connected to the contact body, are held inside the housing so that the sliding movement of the contact body is buffered and assisted. The housing, for example, is configured to have a cage body having an open upper face, forms a long and slender shape following the sliding direction, and is inserted inside a receiving part formed on the upper end of the sliding door. The lower face of the housing generally is flat so that the entirety of the lower face of the housing is supported on a bottom part of a groove.

### PRIOR ART DOCUMENTS

### Patent Documents

Patent Document 1: Japanese Unexamined Patent Publication No. 2007-309088

### SUMMARY OF THE INVENTION

### Problem to Be Solved by the Invention

In the technology described above, because the lower face of the housing is flat so that the entirety of the lower face of the housing is supported on the bottom part of the groove, a high dimensional precision is required between the lower face of the housing and the support surface of the receiving part. It becomes difficult to maintain high positioning precision when the housing is installed on the receiving part in case there exists deviation of dimensions due to the influence of temperature, humidity, or machining precision, or in case scrap or dirt was present during machining.

Therefore, an object of the present invention is to provide a movable body assisting apparatus and a housing with which high positioning precision can be maintained using a simple configuration.

### Means for Solving the Problem

The housing of an assisting apparatus according to the present invention is a housing of an assisting apparatus provided on a receiving part formed on either one of a support body and a movable body that slides in a first direction relative to the support body, and includes a support part that projects in a second direction intersecting with the first direction and is supported on a support surface of the receiving part; and a separated part that stands at a distance from the support surface.

Also, the assisting apparatus according to the present invention comprises the abovementioned housing; a received body that is provided on the other of the support body and the movable body; and a contact body that is capable of coupling and uncoupling with the received body and is provided to be capable of moving along a course of movement from a first position up to a second position on the housing.

### Effect of the Invention

According to the present invention, the influence of dimensional error of the receiving part, and the like, can be avoided, and high positioning precision can be maintained.

### BRIEF DESCRIPTION OF THE DRAWINGS

FIG. 1 is an explanatory diagram illustrating the operation of a sliding door provided with the assisting apparatus according to one embodiment of the present invention.

FIG. 2 is an explanatory diagram illustrating the operation of a sliding door provided with the assisting apparatus according to one embodiment of the present invention.

FIG. 3 is a perspective view of the assisting unit according to the same embodiment.

FIG. 4 is a side view of the assisting apparatus according to the same embodiment.

FIG. 5 is a plan view of the assisting unit according to the same embodiment.

FIG. 6 is an explanatory diagram of the housing according to a second embodiment of the present invention.

FIG. 7 is an explanatory diagram of the housing according to a second embodiment of the present invention.

FIG. 8 is an explanatory diagram of the housing according to a third embodiment of the present invention.

FIG. 9 is an explanatory diagram of the housing according to a third embodiment of the present invention.

### EMBODIMENTS OF THE INVENTION

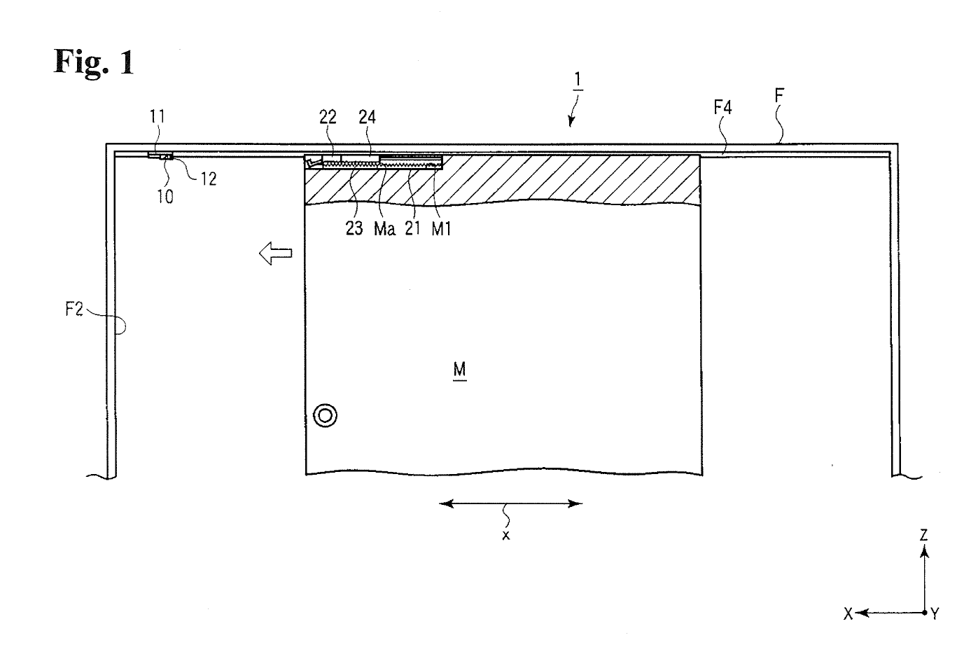

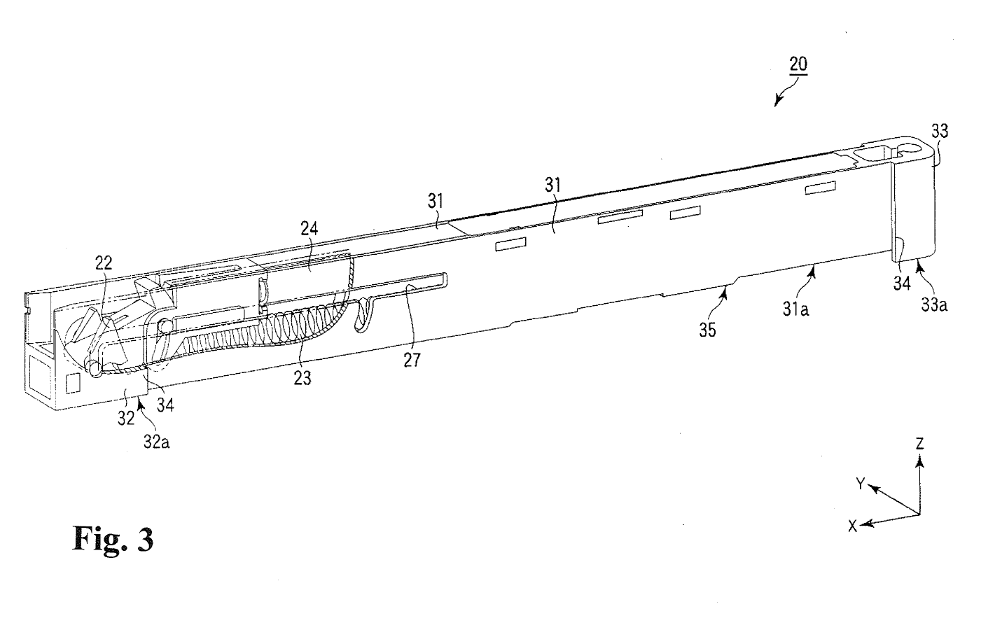

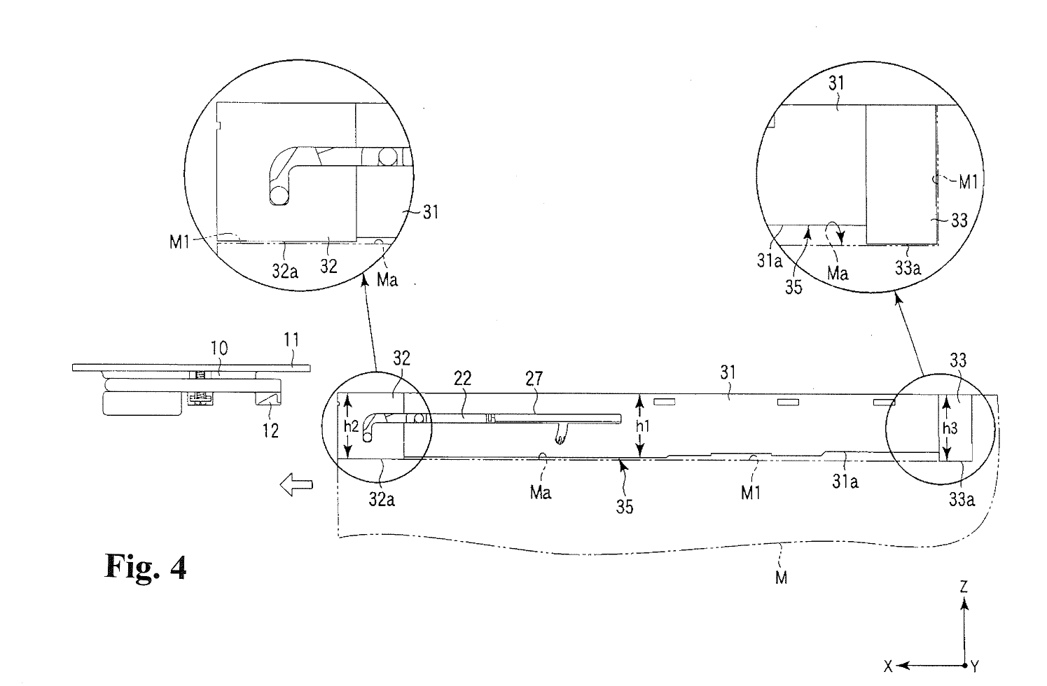

The movable body assisting apparatus 1 according to one example of the present invention is described below while referring to FIGS. 1 through 5. In the drawings, the arrows X, Y, and Z respectively indicate three mutually intersecting directions. Here, for example, the X axis follows the sliding direction (first direction), the Y axis follows the width direction (third direction), and the Z axis follows the vertical direction (second direction). Also, suitable configurations are illustrated enlarged or reduced or are omitted for the purpose of description in each drawing.

As illustrated in FIGS. 1 through 5, the assisting apparatus 1 comprises a striker 10 as a received body provided on either one of a movable body and a support body, and an assisting unit 20 provided on the other of the movable body and the support body.

In the present embodiment, an example is illustrated, in which the support body is a door frame F, the movable body is a sliding door M, the assisting unit 20 is provided on the sliding door M as the movable body, and the striker 10 is provided on the door frame F as the support body.

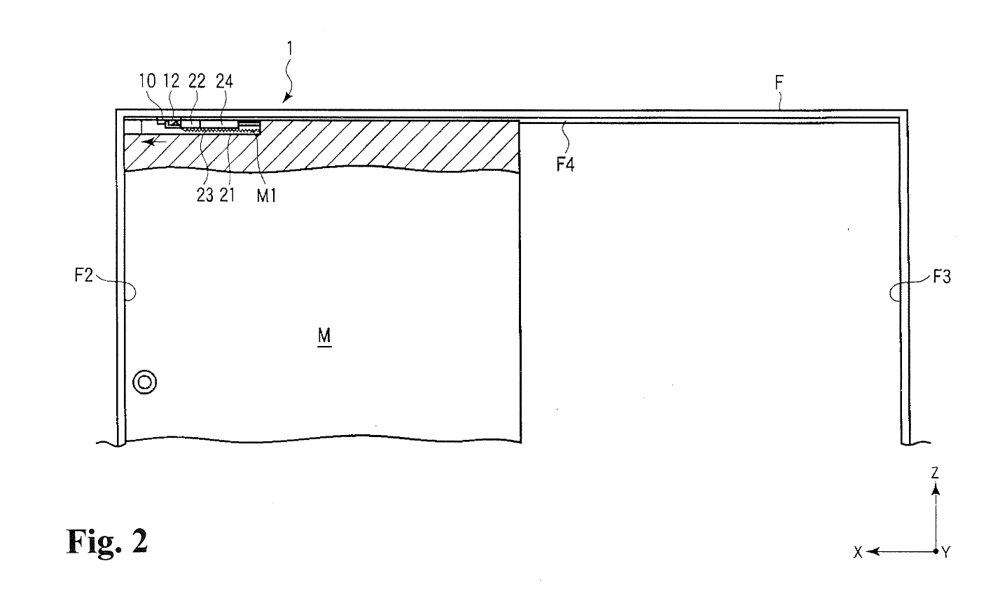

As illustrated in FIG. 1, the door frame F has a sliding door groove F4 following the sliding direction, and the sliding door M is held to be capable of sliding in the sliding door groove F4. The state in which the sliding door M is open and is not in contact with the door frame F2 on the leading end side of the door, as illustrated in FIG. 1, is referred to as the “first state,” and the state in which the sliding door M is closed, is moved completely to the position at the end of movement on the side of the leading end of the door, and is in contact with the door frame F2, as illustrated in FIG. 2, is referred to as the “second state.”

The sliding door M, for example, has a plate form, being made of wood material, for example, natural wood or compressed wood, and a groove M1 as a receiving part for holding the assisting unit 20 is formed on the upper end part thereof. The groove M1 has a bottom part Ma to serve as a support surface for supporting a housing 21, and a side part Mb. The groove M has a long and slender form extending in the sliding direction, one end side in the sliding direction is open, and the other end side is formed in an arc form and is closed. Also, the groove M1 is formed in a long and slender rectangular form in side view. A housing 21 to be described is inserted into the groove M1 from above, and the housing 21 is supported on the bottom part Ma as the support surface.

The assisting apparatus 1 has a striker 10 provided on the door frame F and an assisting unit 20 provided in the groove M1 of the sliding door M.

The assisting unit 20 has a housing 21 that is provided on the upper end part of the sliding door M; a latch 22 as a contact body that is held on the end part on one end side (left side in FIG. 1) in the sliding direction of the housing 21 and is supported to be capable of sliding between a standby position and a drawn-in position; an urging mechanism 23 for urging the latch 22 to the other end side (right side in FIG. 1) in the sliding direction on the housing; and a damping mechanism 24 that is connected to the latch 22 to apply resistance force to the sliding movement of the latch 22.

The striker 10 is provided on the upper end of the door frame F at a fixed position from the left end in the sliding door groove F4. The striker 10 has a plate-form installation member 11 attached to the upper frame F1, and a plate-form coupling member 12 projecting downward from the upper frame F1. The coupling member 12 is captured by the latch 22, whereby the striker couples with the latch 22 and the two move as one body relative to the housing 21. The sliding door M moves relative to the door frame accompanying this relative movement.

The housing 21 has a long and slender box form in the sliding direction with the upper face open as illustrated in FIGS. 1 through 5. The housing 21 has a pair of side walls 31 and 31 facing the Y direction, and a first support part 32 and a second support part 33 on both ends in the X direction, and is integrally formed, for example, by resin molding, or the like. The latch is held to be capable of sliding between the pair of side walls 31 and 31. Lower surfaces 32a and 33a of the support parts 32 and 33 of the housing 21 project further downward than lower edges 31a of the side walls 31 and 31, and are supported on the support surface Ma.

Meanwhile, the lower edges 31a of the side walls 31 and 31 are formed to recede while retreating further upward than the lower surfaces 32a and 33a of the support part 32 and 33, and a separated part 35 standing at a distance above the support surface Ma is formed. Here, the configuration is such that a dimension h1 in the Z direction at the middle part in the sliding direction is smaller than dimensions h2 and h3 in the Z direction at both end parts in the sliding direction.

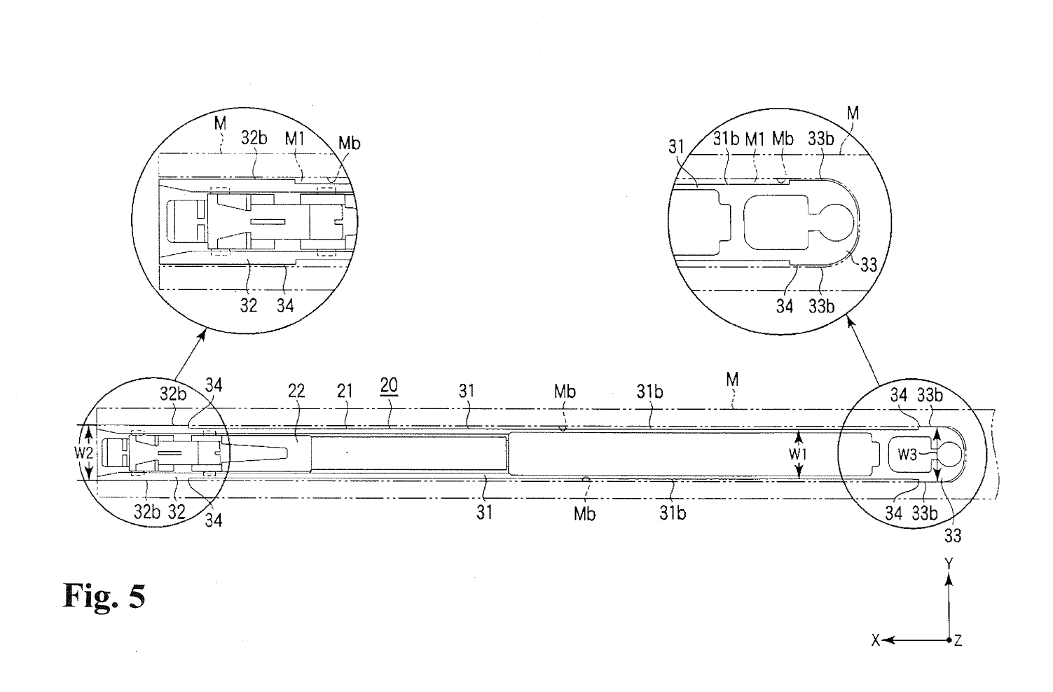

Also, as illustrated in FIG. 5, the support parts 32 and 33 have enlarged parts 34 that are wider than the side walls 31 and 31 in the Y direction. Specifically, the configuration is such that a dimension w1 in the Y direction of the housing at the middle part in the sliding direction is smaller than dimensions w2 and w3 in the Y direction of the support parts 32 and 33 at both ends in the sliding direction. The enlarged parts 34 are formed with higher rigidity than the thin plate-form side walls 31 and 31.

A slit 27 is provided in each of the side walls 31 and 31 of the housing 21. The latch 22 couples in the slits 27 and is supported to be capable of moving in the housing following the slits 27. For example, a tension coil spring 41 as an urging mechanism 23 is provided on the lower part of the housing 21. One end of the tension coil spring 41 is connected to the latch 22 and the other end is anchored on the housing 21, and the tension coil spring urges the latch 22 to the side of the other end in the sliding direction on the housing 21.

A damping mechanism 24 includes a piston damper 50 provided inside the housing 21. The piston damper 50 has a cylinder 51 containing a fluid sealed inside, a piston that moves reciprocating inside the cylinder 51, and a piston rod 52 that is connected to the piston. The damping mechanism 24 applies resistance force to the pushing-in and pulling-out movement of the cylinder 51 or the piston rod 52 by action of fluid resistance of the fluid inside the cylinder 51 on the movement of the piston inside the cylinder 51, so that the sliding movement of the latch 22 against the housing 21 is damped. Typically, silicon oil or another viscous fluid is used as the fluid sealed inside the cylinder 51, but the present invention is not limited to this, and a gas also may be used.

In the assisting apparatus 1 configured as mentioned above, the latch 22 is held in the standby position at the end part of the housing 21 in the neutral first state in which the sliding door M has not reached the striker 10 as illustrated in FIG. 1. When the operator moves the sliding door M toward the doorstop F1 on the left side from this first state and the sliding door M reaches a first prescribed position, the latch 22 contacts with the striker 10 and couples with the striker 10. Also, the latch 22 is moved relatively to the right side relative to the housing 21 and the sliding door M by the tension coil spring 41. The sliding door M and the housing 21 are moved relatively to the left side relative to the support body F and the striker 10 accompanying this movement. At this time, resistance force is applied by the damping mechanism 24, and the sliding door M is moved in the closing direction automatically and gently while being buffered.

Meanwhile, when the sliding door M is operated to be moved to the right side from the second state in which the sliding door M was moved completely to the end position at the left side as illustrated in FIG. 2, the sliding door M moves to the right side while the latch 22 in a state having captured the striker 10 moves relatively to the left side relative to the sliding door M and the housing 21 in opposition to the urging force of the tension coil spring 41. When the sliding door reaches the prescribed position, the coupling between the latch 22 and the striker 10 is released and the latch 22 again is held in the standby position at the end part of the housing 21. The movement of the sliding door M thereafter is opened by the urging force of the tension coil spring 41.

According to the assisting apparatus 1 according to the present embodiment, the housing 21 is supported on the bottom part Ma, being the support surface, at the support parts 32 and 33 formed on a part of the housing, and the separated part 35 standing at a distance from the bottom part Ma, being the support surface, is formed in the center. By this simple configuration, the allowable range of dimension of the separated part 35 can be set wider. Therefore, the housing 21 can be set with high positioning precision and the allowable range of dimensional error can be set wider with a simple configuration, even if there are errors in the dimensions of the support surface of M1, such as when deviation of dimensions has occurred due to temperature, humidity, or machining position of the sliding door or when wood scrap, or the like, is present in the bottom part Ma during machining. Also, both end portions, which have higher rigidity, are used as the support parts 32 and 33 rather than the center portion, which is configured in a thin plate form and has lower rigidity. By this, the influence of dimensional errors can be avoided and high installation precision can be maintained.

### Second Embodiment

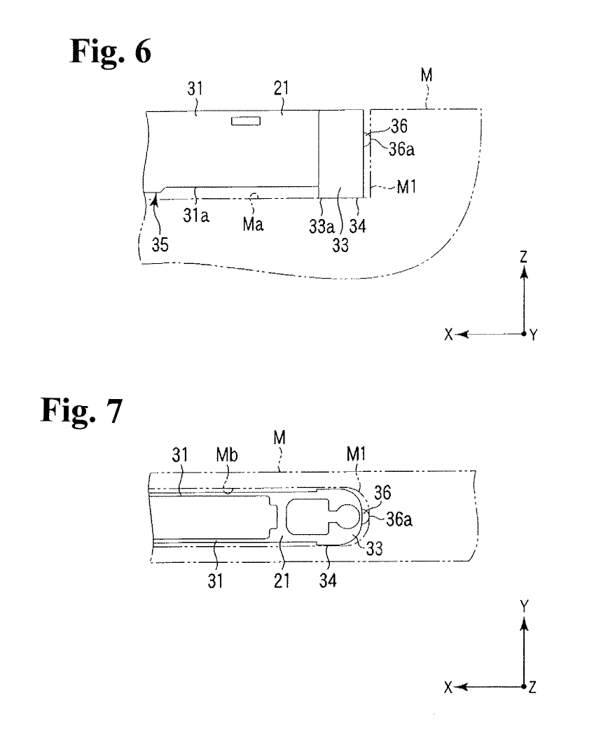

A second embodiment of the present invention is described below while referring to FIGS. 6 and 7. FIG. 6 is a side view enlarging the support part 33 according to the present embodiment, and FIG. 7 is a plan view. Because the present embodiment is identical to the abovementioned first embodiment, except that a projection 36 is provided, common descriptions are omitted.

In the present embodiment, a projection 36 projecting in the X direction is formed on the outer face of the support 33 forming the enlarged part 34. The projection 36, for example, is configured in a hemispherical form, and is formed integrally on the housing 21 by resin molding. A top part 36a of the projection 36 is placed in contact with the wall of the groove M1 of the sliding door M.

The same effect as in the abovementioned first embodiment is obtained also in the assisting apparatus 1 according to the present embodiment. Furthermore, by providing the projection 36, the resistance when the housing 21 is inserted from above and set into the groove M1 is reduced and the setting operation therefore becomes easier. Also, an effect is obtained that the influence of dimensional errors of the groove M1 or housing 21 is avoided also in the sliding direction and positioning is possible with higher precision.

### Third Embodiment

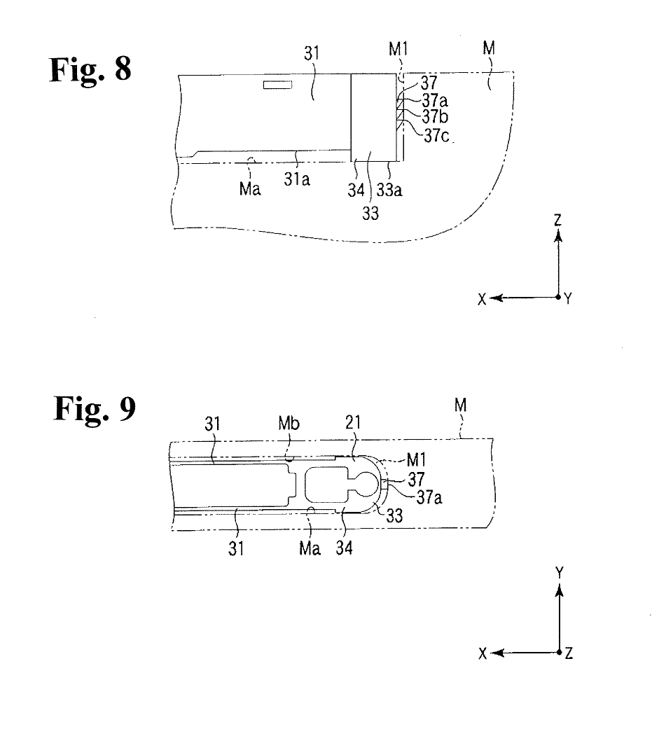

A third embodiment of the present invention is described below while referring to FIGS. 8 and 9. FIG. 8 is a side view enlarging the support part 33 according to the present embodiment, and FIG. 9 is a plan view. Because the present embodiment is identical to the abovementioned first and second embodiments, except for the configuration of a projection 37, common descriptions are omitted.

In the present embodiment, a projection 37 projecting in the X direction is formed on the outer face of the support 33 configuring the enlarged part 34. The projection 37 is configured with three stages of raised lines arrayed in the Z direction, and is integrally molded on the housing 21 by resin molding. Top parts 37a, 37b, and 37c of the three stages of the projection 37 are placed in contact with the wall of the groove M1 of the sliding door M. The three stages of top parts 37a, 37b, and 37c of the projection 37 form a turned-back part projecting with an upward bias. Because of this turned-back shape, the resistance when the housing 21 is moved upward from below and is pulled out from the groove M1 becomes greater than the resistance when the housing 21 is moved downward from above and is inserted in the groove M1. Therefore, the housing 21 can be set easily and it is difficult to pull the housing 21 out from the groove M1.

The same effect as in the abovementioned first and second examples is obtained also in the assisting apparatus 1 according to the present embodiment. Furthermore, because the projection 37 has a turned-back shape having top parts 37a, 37b, and 37c that are biased upward away from the support surface Ma, the resistance when the housing is inserted and set inside the groove M1 is further reduced, and an effect is also obtained that shifting of positioning can be prevented.

The bottom part Ma serving as the support surface is made planar in the abovementioned embodiments, but the present invention can be applied also in the case when there are steps on the support face. In this case as well, the same effect as in the abovementioned embodiments is obtained by providing a support part for contacting with the support surface and the separated part standing at a distance above the support surface.

The present invention is not limited to the aforementioned embodiments, and all kinds of modifications can be implemented within a scope that does not deviate from the main point of the present invention. Also, the specific configurations or materials of each part, or the like, are not limited to those illustrated in the abovementioned embodiments, and can be suitably changed.

The entire contents of the specification, claims, drawings, and abstract of Japanese Patent Application No. 2011-055894 filed on Mar. 14, 2011 are incorporated by reference herein as a disclosure of the specification of the present invention.

1. A housing of an assisting apparatus provided on a receiving part formed on either one of a support body and a movable body that moves sliding in a first direction relative to said support body, comprising:
a support part that projects in a second direction intersecting with said first direction and is supported on a support surface of said receiving part; and
a separated part that stands at a distance from the support surface.

2. The housing of an assisting apparatus according to claim 1, wherein said support part is provided on both end parts in said first direction, and said separated part is formed to recede so as to stand at a distance from said support surface at the center part in said first direction; and
said support part forms an enlarged part that is formed to project in a third direction intersecting with said first direction and said second direction.

3. The housing of a movable body assisting apparatus according to claim 1, wherein said support part has higher rigidity than said separated part.

4. The housing of an assisting apparatus according to claim 1, wherein a projection that projects outward in the first direction is formed on the outer surface of said support part.

5. The housing of an assisting apparatus according to claim 1, wherein said projection has a top part that projects toward a direction away from the support surface in said second direction, and has a turned-back shape.

6. A movable body assisting apparatus, comprising:
the housing according to claim 1;
a received body that is provided on the other of said support body and said movable body; and
a contact body that is capable of coupling and uncoupling with said received body and is provided to be capable of moving along a course of movement from a first position up to a second position on said housing.
